(19) United States
(12) Patent Application Publication
(10) Pub. No.: US 2012/0164609 A1
(43) Pub. Date: Jun. 28, 2012

(54) Second Language Acquisition System and Method of Instruction

(76) Inventor: Thomas David Kehoe, Boulder, CO (US)

(21) Appl. No.: 12/978,402

(22) Filed: Dec. 23, 2010

(51) Int. Cl. G09B 19/06

(52) U.S. Cl. 434/157

(57) ABSTRACT

A system for second language acquisition that trains the user's brain's auditory processing area to recognize phonemes, syllables, and words of a foreign language, by presenting videos of a word or phrase spoken at a slow rate and at a normal rate, and an interface for the user to enter the phonemes, syllables, and words that he or she has heard, with immediate responses indicating correct or incorrect entries. Additionally, said system for second language acquisition teaches simplified vocabulary and grammar; enables users to add additional vocabulary and languages; teaches via auditory, visual, and kinaesthetic (movement) methods; and can be used on small mobile devices such as cellular telephones.

### FIELD OF THE INVENTION

This invention relates generally to the field of second language acquisition or foreign language learning, and more specifically to a system and method for providing instruction in a foreign language.

### BACKGROUND

The goals of second language acquisition include vocabulary, grammar, pronunciation, and listening comprehension; for reading, writing, speaking, and listening.

Second languages can be learned via a variety of methods. Many schools and colleges offer foreign language classes. Books, audiotapes, and videos are available. A variety of instructional computer software applications are sold.
Books can be effective for learning vocabulary and grammar to read and write a second language, but poor for learning pronunciation and listening comprehension.
Audiotapes and videos can improve listening comprehension but typically are too complex for beginning learners, featuring dialogs presenting hundreds of words at a speaking rate too fast for students to understand.
Computer software typically shows pictures, displayed with the foreign word and translation, and plays an audio file of a native speaker saying the word. This can be effective for building noun and verb vocabulary, but it is less effective for teaching grammar and other parts of speech, such as pronouns, adjectives, adverbs, prepositions, conjunctions, and interjections.

Typically students learn to read and write a second language, to speak acceptably, and to fail to understand native foreign speakers speaking at a normal speaking rate. It is generally believed that the only way to learn to hear a foreign language is to study the language while living in a foreign country, where one hears native speakers on a daily basis, for at least six months.

Language learning occurs in at least two brain areas: the language area, where vocabulary and grammar are learned; and the auditory processing area, where streams of sound are parsed into useful information. Methods of second language acquisition typically train the brain's language area, with little or no training of the brain's auditory processing area. Without the latter training, hearing a foreign language at a normal speaking rate doesn't sound like words, but rather sounds like streams of gibberish.

Researchers divided American students learning Japanese into three groups. (“Training native English speakers to identify Japanese vowel length contrast with sentences at varied speaking rates,” Yukari Hirata, Elizabeth Whitehurst, and Emily Cullings. Journal of the Acoustical Society of America, June 2007, Volume 121, Issue 6, pp. 3837-3845.) The first group heard Japanese spoken at a normal speaking rate. The second group heard Japanese spoken at a slow rate. The third group heard Japanese spoken both slowly and at a normal rate (typically slow, then fast). At the end of the course, the third group was best able to understand spoken Japanese, the second group was next best, and the first group was least able to understand spoken Japanese.

Learning a second language is one of the most difficult of undertakings for adults. Fluency at even a basic level demands one thousand hours or more of work. The work of learning a second language is dull, with many mistakes and few rewards. Because students typically fail to master listening comprehension, hearing a native speaker say a word or phrase that a student knows how to read and write makes the student feel stupid.

It has also been established that some students are auditory learners, e.g., they learn from hearing lectures. Other students are visual learners, e.g., they learn from viewing drawings or videos. Still other students are kinaesthetic or movement learners, who learn via physical movements such as taking something apart and putting it back together. In general, students learn best when material is taught with a combination of auditory, visual, and movement techniques. Methods of second language acquisition tend to be heavy on auditory learning, with less visual learning, and little or no movement learning.

There are today between 5,000 and 10,000 languages spoken in the world. English dominates second language learning, with over one billion people now learning English. Three languages—Spanish, French, and German—comprise 70% of enrollments in American college and university second language courses. Fifteen languages comprise ninety-eight percent of enrollments. Only about thirty or forty languages are available in computer-based second language training applications. At the other end of the spectrum, about five hundred languages are classified as “nearly extinct.” Students have little opportunity to learn more than 99% of languages. E.g., a Native American who grew up off the reservation and wishes to learn his or her ancestral language has few choices other than moving back to the reservation. There is a need for a system to teach such obscure languages.

Another need is for a second language acquisition system that can be used on small mobile devices such as cellular telephones. At present only flash card programs and podcasts are available for mobile devices.

It has been determined that the need exists for an improved method for second language acquisition that better trains listening comprehension; makes students feel more rewarded; teaches minor or obscure languages; integrates auditory, visual, and movement learning; and can be used on small mobile devices.

### SUMMARY

To achieve the foregoing and other objects and in accordance with the purpose of the present invention broadly described herein, one embodiment this invention comprises a system for second language acquisition. The system includes a compilation of video and audio information that represents syntactics selected from phonemes, sounds, syllables, combinations of consonants and vowels, words, phrases, sentences, and combinations thereof. The compilation includes information recorded at a normal speaking rate and at a slower than normal speaking rate. In addition, the system comprises means for providing the information to a user in a format selected from video, audio, and combinations thereof.

The system may further comprise means for representing the syntactic information as user-selectable interface features selected from keys, buttons, checkboxes, sliders, and text fields; and means for informing a user of correct and incorrect selection of the interface features, corresponding to the syntactic information. The interface features may be color-coded, with different colors representing different phonemes, syllables, and combinations of consonants and vowels. Additionally, the system may comprise means for presenting the interface features aurally. The syntactic information may be selected from simplified vocabulary, simplified grammar, and combinations thereof. The system may also comprise software implementing a spaced repetition learning technique for providing the compilation to the user. The means for providing may be selected from cellular telephones and other small mobile electronic devices. Also, the system may further comprise means for allowing a user to add new information selected from sounds, words, phrases, and combinations thereof. The system may further comprise means for allowing a user to add one or more new languages. The system may further comprise means for allowing a first user to find a second user to help the first user learn a language.

Another embodiment of the invention comprises a method for second language acquisition. The method comprises the steps of providing a compilation of video and audio information, the information representing syntactics selected from phonemes, sounds, syllables, combinations of consonants and vowels, words, phrases, sentences, and combinations thereof, wherein the compilation includes information recorded at a normal speaking rate and at a slower than normal speaking rate; and providing the information to a user in a format selected from video, audio, and combinations thereof.

The method may further comprise the steps of representing the syntactic information as user-selectable interface features selected from keys, buttons, checkboxes, sliders, and text fields; and informing a user of correct and incorrect selection of the interface features, corresponding to the syntactic information. The representing step may comprise representing the syntactic information using color coding. The method may further comprising the step of presenting the interface features aurally. The syntactic information may be selected from simplified vocabulary, simplified grammar, and combinations thereof. The method may further comprise the step of providing the compilation to the user using a software-implemented spaced repetition learning technique. The step of providing the information may comprise transmitting the information to a device selected from cellular telephones and other small mobile electronic devices. The method may further comprise the step of allowing a user to add new information, the new information selected from sounds, words, phrases, and combinations thereof. The method may further comprise the step of helping a first user to find a second user for assistance in learning a language.

### DRAWINGS

These and other features, aspects, and advantages of the present invention will become better understood with reference to the following description, appended claims, and accompanying drawings, where:

FIG. 1 is a screen shot of an English phonemes table.

FIG. 2 is a screen shot of a Spanish syllables table.

### DESCRIPTION

The system of the present invention trains a user's brain's auditory processing area to recognize the phonemes and syllables of a foreign language, i.e., parse streams of gibberish into words, which his or her brain's language area can then recognize.

### Overview

In one embodiment of the system for second language acquisition, two video screens are presented to a user for viewing. One video screen plays a recording of a native speaker saying a word or phrase slowly and clearly; the second video screen shows the same speaker saying the word or phrase at a normal speaking rate.

Below the two video screens are arrays of color-coded buttons representing all the phonemes of a language, grouped into vowels and consonants. The user then clicks on the buttons to indicate the phonemes he or she has heard, and receives immediate feedback of correct and incorrect choices. If a user is unsure what a phoneme sounds like, a right-click on a phoneme button plays a recording of that phoneme.

When the user masters recognizing the phonemes of a language, he or she moves on to seeing similar videos, but with the arrays of phonemes replaced with columns of syllables. He or she again selects the syllables he or she heard in the video. This trains the user to recognize what are acceptable syllables in a language. E.g., in Spanish, only six syllables start with “ba”: bal, ban, bañ, bar, bas, bat. With practice the user will reject words with “bak” (e.g., “bacteria”) as not Spanish, i.e., the user's auditory processing area will recognize syllables before the user's language area becomes aware of the sounds.

The words and phrases presented at the beginner level comprise the approximately 2000 most common words that comprise approximately 80% of the spoken language. This simplified vocabulary is combined with simplified grammar to make a simplified version of the language.

The words and phrases are presented to the user using a software-implemented spaced repetition learning technique, such as the popular software application Supermemo, which improves speed of learning and retention.

The user can access the second language acquisition system via a computer or via a cellphone or other portable electronic device. Lastly, the user can upload new words or phrases, or even add a new language.

### Podcasts

To make the language learning system more entertaining and compelling to the user, the user uses a computer or mobile device such as a cellphone to watch an audio or video podcast. The podcast might be news, a feature story, or telenovela (soap opera). The user may have a choice of levels, such as beginner, intermediate, and advanced.

The beginner level is characterized by very slow and clear speech, limited vocabulary, and simplified grammar (e.g., all verbs in the present tense). Conjugated verbs may be repeated in their infinitive with their pronoun, e.g., “Hablo—yo hablar—con tu madre.” Slow speech is presented with longer vowels and longer stops between words to improve intelligibility.

Accompanying the podcast is a vocabulary list of new words introduced in the podcast. Each word is introduced in a screen with two video windows. Clicking the left window plays a video at a normal speaking rate. Clicking the right window plays the word spoken slowly and clearly. This trains the user's auditory processing to recognize the sounds of the word, similar to the instructor of Japanese speaking slowly and at a normal speaking rate.

### Slow Speech

Speech can be slowed in a variety of ways. Software applications can speed up or slow down an audio file, while maintaining pitch. However, slowing speech with such software typically makes the speech harder to understand. Normal speech joins words together, and the software makes it harder to hear where one word ends and the next word begins. The cues of consonant-vowel transitions become harder to hear. Additionally, the sound quality degrades as it slows down.

In contrast, speech-language pathologists train stutterers and other persons with speech disorders to slow their speech by stretching vowel sounds without slowing consonants, especially unvoiced consonants (consonants without vocal fold vibration, such as /s/ and /t/). When the speaker adds short pauses between slowed words, the speech becomes easy for second language learners to understand.

This latter method is preferred in this system, i.e., native speakers trained to speak slowly and clearly, not speech slowed via software.

### Phoneme Buttons

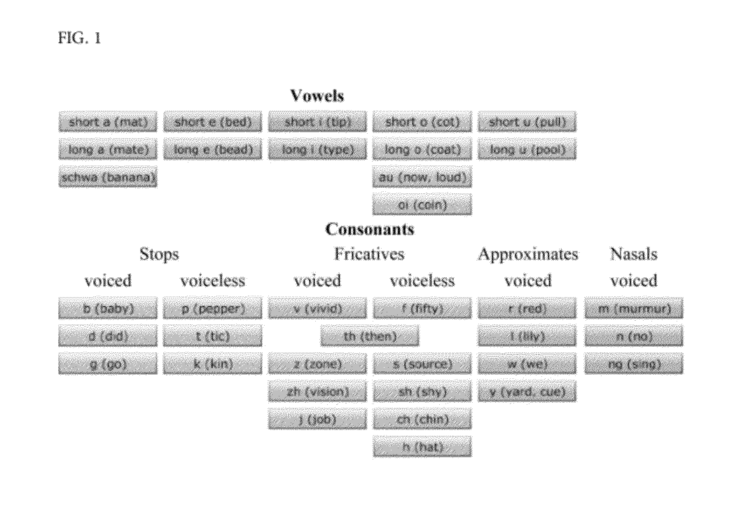

On a screen display, below the video windows, are arrays of buttons with the phonemes of the target language, shown for English in FIG. 1. Commercially available software, such as Adobe Flash, may be used to create the buttons. The user clicks on the phonemes he or she has heard on the video.

English has about fifteen to twenty vowels and about twenty-five consonants; most languages have fewer phonemes, typically about ten vowels and about twenty consonants. As shown in FIG. 1, the buttons are arranged with the vowels in a separate group from the consonants. The vowels are typically organized in a matrix by /a/, /e/, /i/, /o/, and /u/, and by long and short. The consonants are organized into stops, fricatives, approximates, and nasals, and sub-divided further into voiced and voiceless sounds. The buttons may be color-coded to provide visual cues.

The buttons display the letter (or combination of letters) most associated with the phoneme, and an example word. The user can right-click on a button to hear an audio file of the example word.

In one embodiment, when the user left-clicks a correct button, it changes to bright green and appears in a “phrase line” below the videos and above the button arrays. When a user left-clicks an incorrect button, an error sound is played and the button color changes to red for a few seconds. It should be noted that this embodiment is described with visual and auditory feedback, although other sensory feedback, such as tactile feedback, could be provided.

Users receive immediate feedback at each mouse click or keystroke. Immediate rewards motivate users to continue. Validation programming, such as Asynchronous JavaScript and XML (AJAX), provides the immediate feedback.

### Syllable Columns

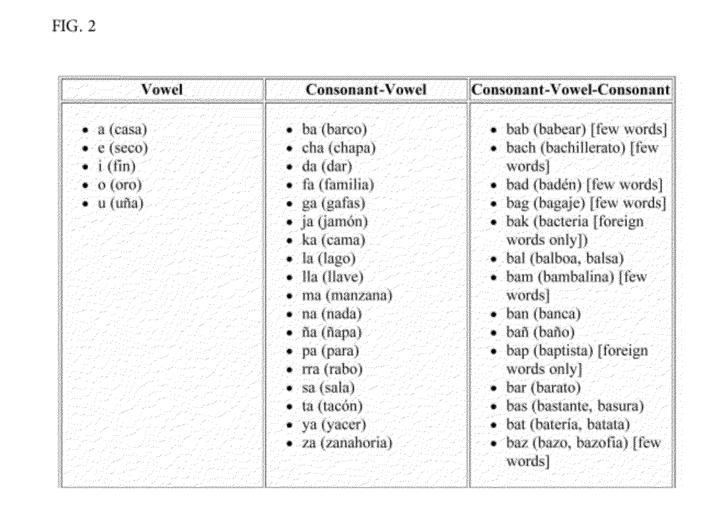

After completing the phoneme buttons module of instruction, the user proceeds to the next module of instruction (FIG. 2), which displays consonant-vowel-consonant combinations, i.e., syllables in a multi-column table. The user then selects the syllables he or she has heard.

The left column includes all of the vowels of the language, color-coded similarly to the phoneme buttons. Hovering the mouse over a vowel causes a list of consonant-vowel and vowel-consonant syllables to display in the middle column, with the vowel that the user selected from the left column.

Hovering the mouse over a syllable in the middle column causes a list of consonant-vowel-consonant syllables to appear in the right column, with the vowel that the user selected from the left column and the consonant that the user selected from the middle column.

For syllables with additional consonants, e.g., the German word “schwartz” (meaning “black”), a fourth column may be used to display all syllables containing the consonant-vowel-consonant configuration of the third column. This fourth column may be omitted for the sake of simplicity.

Selecting syllables from the syllable tables trains the user's brain's auditory processing area to recognize syllables. For example, FIG. 2 shows that Spanish only has six syllables starting with “ba”: bal, ban, bañ, bar, bas, bat. With practice the user will reject without conscious thought words with “bak” (e.g., “bacteria”) as not Spanish, i.e., the user's auditory processing area will recognize syllables before the user's language area becomes aware of the sounds.

The syllables may be color-coded with the vowels matching the colors of the phonemes buttons (FIG. 1). Additionally, the consonant buttons may be color- or pattern-coded, e.g., brown diagonal stripes for fricatives.

Each syllable button has a sample word displayed. Right-clicking on the button plays an audio file of the word.

When the user left-clicks on a correct button, the button color changes to green and the syllable appears in the “phrase line” below the video screens and above the syllable table. When the user left-clicks an incorrect button, an error sound is played and the button color changes to red for a few seconds.

### Sentence Screens

In the next instruction module, the user is presented with sentences, recorded at normal and slow speaking rates. At the beginner level, the user sees the words in the sentence, in a table with each column a part of speech (noun, verb, pronoun, adjective, adverb, preposition, conjunction, and interjection). The user then clicks on the words in the order of the sentence to form the sentence in the “phrase bar,” and then sees the sentence displayed and translated. Correct clicks change the color of the word to green; incorrect clicks change the color to red and produce an error sound.

For advanced users, textfield forms are displayed for each word. The user types each word of the sentence.

Thus users begin with the simplest, shortest part of speech: the phoneme. When they master their ability to hear phonemes of the target language (by hearing the target words at slow and at normal speaking rates) they move on to syllables, and then to words, then to sentences. The user learns first to hear a word, and then to read it, and then to spell it.

### Auditory, Visual, and Movement Learners

Correct responses on the screens present the word spelled and translated. There may also be as picture or video showing the word's meaning. There may be a mnemonic aid, for example, a common Latin root for a Spanish word and an English word; or picturing the Russian word dom, meaning house, as a house with a Russian onion dome on top.

This method combines auditory, visual, and kinaesthetic (movement) learning. The words are heard, the speakers seen, and pictures illustrating the words are seen. The phoneme and syllable buttons are color coded, training a visual learner to associate colors with sounds. Kinaesthetic learners prefer to take apart an object and put it back together. In this method, the user takes apart words into sounds and put them back together syllable by syllable.

### Simplified Languages

The Voice of America developed Special English in 1959 for broadcasting news and feature stories to listeners whose native language isn't English. It has a vocabulary of 1500 words and simplified grammar. The VOA broadcasts are useful for intermediate English learners but are less helpful for beginners.

In most languages a vocabulary of 2000 words covers 80% of words used in the language. By focusing on the most used words, instead of the obscure words and phrases often taught in second language courses, users can become fluent in a language faster.

The user may also receive grammar lessons and/or view videos of words used in context or words pronounced with different regional accents.

### SuperMemo

Words are introduced using SuperMemo or similar spaced repetition learning technique software. SuperMemo could be described as an intelligent flashcard deck. It recognizes when a user has learned a word and drops it from the deck, while repeating words the user gets wrong and introducing new words to replace learned words.

SuperMemo is a software application made by SuperMemo World, of Poznan, Poland.

### Wild Features

An additional, optional feature of the system includes an area where users may upload new words and phrases. If the user has a video camera attached to his or her computer (a “webcam”) he or she can easily upload the normal and slow speaking rate videos. For example, a doctor may add medical terms for his or her field, or a native of a region may add regional words or phrases.

Users may also upload new languages, by providing the phonemes of the language, a pronunciation guide, and sample words for each phoneme, with audio files.

These features enable the system to use volunteer labor to offer obscure languages that would otherwise be unprofitable to offer. For example, the Blackfeet Tribal Council could add the Blackfeet language.

### Language Exchange

The language learning system may also include a language exchange such as Skype video chatting with people in other countries, to help users improve their pronunciation. The language exchange area is searchable by age, gender, location, etc. This feature could also enable working with tutors.

With this combination of integrated features, users may be able to watch podcasts; use interactive materials to build vocabulary, improve listening comprehension, and learn grammar. There may also be a method to communicate with tutors or language exchange partners. The system and method may provide opportunities for rapid learning during “downtime” (such as exercising) that would otherwise be unproductive, and for retaining a language that is otherwise not being used.

The foregoing description is considered as illustrative only of the principles of the invention. Further, since numerous modifications and changes will readily occur to those skilled in the art, it is not desired to limit the invention to the exact construction and process shown and described above. Accordingly, all suitable modifications and equivalents may be resorted to falling within the scope of the invention.

What is claimed is:

1. A system for second language acquisition, comprising:
a compilation of video and audio information, said information representing syntactics selected from phonemes, sounds, syllables, combinations of consonants and vowels, words, phrases, sentences, and combinations thereof, wherein said compilation includes information recorded at a normal speaking rate and at a slower than normal speaking rate; and
means for providing said syntactic information to a user in a format selected from video, audio, and combinations thereof.

2. The system for second language acquisition, as claimed in claim 1, further comprising:
means for representing said syntactic information as user-selectable interface features selected from keys, buttons, checkboxes, sliders, and text fields; and
means for informing a user of correct and incorrect selection of said interface features, corresponding to said syntactic information.

3. The system for second language acquisition, as claimed in claim 2, wherein said interface features are color-coded, with different colors representing different syntactic information.

4. The system for second language acquisition, as claimed in claim 2, further comprising means for presenting said interface features aurally.

5. The system for second language acquisition, as claimed in claim 2, further comprising means for allowing said user to add additional syntactic information.

6. The system for second language acquisition, as claimed in claim 2, further comprising means for allowing a user to add one or more new languages.

7. The system for second language acquisition, as claimed in claim 2, further comprising means for allowing a first user to find a second user to help said first user learn a language.

8. The system for second language acquisition, as claimed in claim 1, wherein said syntactic information is selected from simplified vocabulary, simplified grammar, and combinations thereof.

9. The system for second language acquisition, as claimed in claim 1, further comprising software implementing a spaced repetition learning technique for providing said compilation to the user.

10. The system for second language acquisition, as claimed in claim 1, wherein said means for providing is selected from cellular telephones and other small mobile electronic devices.

11. A method for second language acquisition, comprising the steps of:
providing a compilation of video and audio information, said information representing syntactics selected from phonemes, sounds, syllables, combinations of consonants and vowels, words, phrases, sentences, and combinations thereof, wherein said compilation includes information recorded at a normal speaking rate and at a slower than normal speaking rate; and
providing said information to a user in a format selected from video, audio, and combinations thereof.

12. The method for second language acquisition, as claimed in claim 11, further comprising the steps of:
representing said syntactic information as user-selectable interface features selected from keys, buttons, checkboxes, sliders, and text fields; and
informing a user of correct and incorrect selection of said interface features, corresponding to said syntactic information.

13. The method for second language acquisition, as claimed in claim 12, wherein said representing step comprises representing said syntactic information using color coding.

14. The method for second language acquisition, as claimed in claim 12, further comprising the step of presenting said interface features aurally.

14. The method of second language instruction, as claimed in claim 12, further comprising the step of allowing a user to add additional syntactic information.

15. The method of second language instruction, as claimed in claim 12, further comprising means for allowing said user to add additional languages.

17. The method for second language acquisition, as claimed in claim 11, further comprising the step of helping a first user to find a second user for assistance in learning a language.

18. The method for second language acquisition, as claimed in claim 11, wherein said syntactic information is selected from simplified vocabulary, simplified grammar, and combinations thereof.

19. The method for second language acquisition, as claimed in claim 11, further comprising the step of providing said compilation to the user using a software-implemented spaced repetition learning technique.

20. The method for second language acquisition, as claimed in claim 11, wherein said step of providing said information comprises transmitting said information to a device selected from cellular telephones and other small mobile electronic devices.
